(19) United States
(12) Patent Application Publication
(10) Pub. No.: US 2016/0110068 A1
(43) Pub. Date: Apr. 21, 2016

(54) SYSTEMS AND METHODS TO ENHANCE USER EXPERIENCE IN A LIVE EVENT

(71) Applicant: Sean VOGT, Elk Mound, WI (US)

(72) Inventor: Sean VOGT, Elk Mound, WI (US)

(21) Appl. No.: 14/884,288

(22) Filed: Oct. 15, 2015

Related U.S. Application Data
(60) Provisional application No. 62/064,292, filed on Oct. 15, 2014.

(51) Int. Cl. G06F 3/0484; G06F 1/16

(52) U.S. Cl. CPC G06F 3/04842; G06F 1/163

(57) ABSTRACT

A method for enhancing a user's experience at a live event is described. The method includes providing an application for computing device, the computing device including a display, the application permitting a user to concurrently display one or more screens on the display, the one more screens including additional content to supplement the live event; receiving a request to view one of the one or more screens; generating a user interface for displaying a requested screen corresponding to the one of the one or more screens; and providing the user interface for display on the computing device.

### FIELD

Embodiments of this disclosure relate generally to systems and methods to enhance a user experience at a live event. More specifically, the embodiments relate to system and methods to enhance a user experience at a live event by providing additional content to a viewer of a live event.

### BACKGROUND

Live events such as, but not limited to, music concerts, theatrical performances, sporting events, and the like, often include limited chances for an event attendee to connect with the subject matter of the event and the event producers (e.g., actors, musicians, etc.). Typically, an attendee's experience may be limited by, for example, a location at which the attendee is sitting, etc.

Improved ways to enhance an event-attendees experience are desirable.

### SUMMARY

Embodiments of this disclosure relate generally to systems and methods to enhance a user experience at a live event. More specifically, the embodiments relate to system and methods to enhance a user experience at a live event by providing additional content to a viewer of a live event.

In some embodiments, contents can be fed to a display device carried by a user. Examples of display devices carried by a user include, but are not limited to, a wearable optical head-mounted display (e.g. Google™ Glasses, etc.), other wearable device (e.g., a smart watch, etc.), a tablet, a smart phone, a portable TV, or other suitable display device carried by the user in the live event.

In some embodiments, the contents can be fed to the display device based on an event key. In some embodiments, the event key may be, for example, a timeline in the live event, an order of pieces played in the live event (e.g., an order of songs or music pieces played in a concert, etc.), an event camera angle, etc.

In some embodiments, the contents displayed may be relevant to an occurring event (e.g. a music piece or a song being played, an artifact piece being viewed, a team being watched, etc.) in the live event. In some embodiments, the contents may be generated or chosen by a content creator before the live event or during the event. The user's experience in the live event may be enhanced by viewing the relevant contents displayed in the display device, which may be different from what the user sees in the live event.

In some embodiments, the display device may display a main screen and a plurality of secondary screens that are smaller than the main screen. The plurality of secondary screens may be configured to display different contents that are available at the moment in the live event. The user can choose the content to be displayed in the main screen from the secondary screens. In some embodiments, the secondary screens can be arranged as a row located at a lower portion of the main screen, or below the main screen.

In a live event, the contents to be displayed in the secondary screens may change based on the event key. For example, in a live concert, the contents to be displayed in the secondary screens may change based on the music piece or the song that is being played in the live concert. When the music piece or the song being played changes, the contents displayed in the secondary screens change. In an exhibition, for example, the contents to be displayed in the secondary screen may change based on the artifact piece that is being viewed by the user. When the user moves from one artifact piece to another artifact piece, the contents displayed in the secondary screen change.

The contents generated or chosen by the content creator can be varied, but generally are relevant to the occurring event. In the concert, for example, the contents may include a camera angle(s) that is different from the user, information about an artist on stage, a music score, information that may be helpful for the user to have a better understanding or appreciation of the occurring event, relevant videos/audio/photographic files from the Internet (e.g. videos from streaming services, videos from YouTube, etc.). Since the contents are generated or chosen by the content creator, the content creator can generally have control over the user's experience in the live event, which may be important for achieving desired effect in the live event.

A method for enhancing a user's experience at a live event is described. The method includes providing an application for computing device, the computing device including a display, the application permitting a user to concurrently display one or more screens on the display, the one more screens including additional content to supplement the live event; receiving a request to view one of the one or more screens; generating a user interface for displaying a requested screen corresponding to the one of the one or more screens; and providing the user interface for display on the computing device.

A live event enhancing system is described. The system includes an application that is loadable onto a computing device, the computing device including a display, and that when loaded onto the computing device permits the computing device to display one or more screens on the display, communicate with a server to receive the one or more screens to be displayed; the server able to communicate with the computing device and configured to receive a request for content from the computing device, identify the content, and send the content to the application, wherein the content includes one of a live stream from a live event at which the computing device is located and a prerecorded content corresponding to the live event at which the computing device is located.

A method is described. The method includes providing a wearable computing device in a live event venue, the wearable computing device including an application configured for a user to view supplemental content for a live event while the live event is occurring; and displaying the supplemental content to the wearable computing device.

### BRIEF DESCRIPTION OF THE DRAWINGS

References are made to the accompanying drawings that form a part of this disclosure, and which illustrate embodiments in which the systems and methods described in this specification can be practiced.

FIG. 1 illustrates a schematic diagram of a display of a user's device when using a live event enhancing system as described in this specification, according to some embodiments.

FIG. 2 illustrates a schematic diagram of a display of a user's device when using a live event enhancing system as described in this specification, according to some embodiments.

FIG. 3 illustrates a schematic diagram of a display of a user's device when using a live event enhancing system as described in this specification, according to some embodiments.

FIG. 4 illustrates a schematic diagram of a display of a user's device when using a live event enhancing system as described in this specification, according to some embodiments.

FIG. 5 illustrates a system to enhance a user's experience in a live event, according to some embodiments.

FIG. 6 is a schematic diagram of an architecture for a user device, according to some embodiments. Like reference numbers represent like parts throughout.

### DETAILED DESCRIPTION

Embodiments of this disclosure relate generally to systems and methods to enhance a user experience at a live event. More specifically, the embodiments relate to system and methods to enhance a user experience at a live event by providing additional content to a viewer of a live event.

A live event, as used in this specification, includes, for example, any activity which a content provider can enhance through provision of supplemental content. For example, a live event can include, but is not limited to, a concert, an exhibition, a visit to an art gallery, a visit to a museum, a visit to a historical site or other monument, a visit to a tourist attraction, a theatrical performance, a sporting event, other performance, or the like. In some embodiments, a live event can also include other occurrences. For example, the live event in some embodiments, can include a medical operation, a laboratory test or other experiment, construction (e.g., of a building, etc.), etc. In such embodiments, supplemental content for the live event may include prerecorded content that is specific to the particular occurrence. For example, in an embodiment in which the live event is construction, a user may be able to review construction plans (e.g., blueprints, etc.) or other instructional information.

A screen, as used in this specification, includes, for example, a portion of a display of a user device (e.g., a head-mounted display, smart phone, etc.). A screen, as used in this specification, is not a separate physical device. In some embodiments, a screen can alternatively be referred to as a frame, a window, or other portion of a display of the user's device.

A wearable computing device, as used herein, generally refers to any computing device that is wearable by an individual. More particularly, a wearable computing device generally includes a display (e.g., an optical head-mounted display). Suitable wearable computing devices are, for example, available from Google Inc. The wearable computing device can be a head-wearable computing device.

A head-wearable computing device, as used herein, generally refers to a wearable computing device that is designed to be worn on a person's head. The head-wearable computing device can be in a form of glasses, or wearable similar to glasses, a hat or visor including a computing device and a display visible to the individual, a helmet including a computing device and a display, or other similar computing device that the individual can wear and operate in a hands-free or substantially hands-free manner.

Various embodiments are described below. It is to be understood that the features described in different embodiments can be combined, and the features illustrated in each embodiment can be modified. For simplicity of this specification, a live event is generally discussed with respect to a music concert. It will be appreciated that the various embodiments can be modified according to the particular type of live event, and that the examples are not exclusive to a music concert.

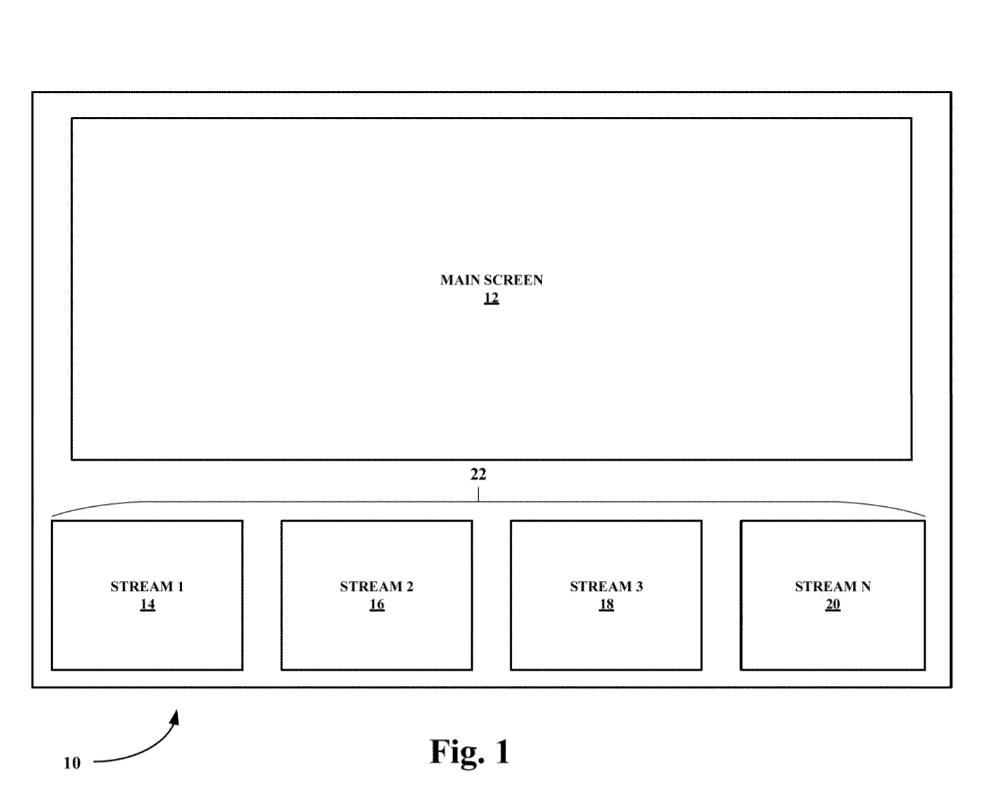

FIG. 1 illustrates a schematic diagram of a display 10 of a user device when using a live event enhancing system as described in this specification, according to some embodiments. In the illustrated embodiment, the display 10 includes a main screen 12 and a plurality of secondary screens 22. The secondary screens 22 include screen 14 (stream 1), screen 16 (stream 2), screen 18 (stream 3), and screen 20 (stream N). In FIG. 1 the secondary screens 22 include four screens 14-20. It will be appreciated that the number of secondary screens 22 is intended as an example. Accordingly, the number of secondary screens 22 can be less than four in some embodiments and can be greater than four in some embodiments. The layout of the main screen 12 and the secondary screens 22 is also intended as an example. It will be appreciated that other layouts can function according to principles described in this specification. A user (e.g., an audience member at a live event such as, but not limited to, a concert, or the like) can select from the plurality of secondary screens 22 to cause content from the selected one of the secondary screens 22 to be displayed in the main screen 12. The shape and size of the main screen 12 and the secondary screens 22 are intended as examples. It will be appreciated that the general size, shape, and layout of the main screen 12 and secondary screens 22 can vary. For example, in some embodiments, the secondary screens 22 can be cascaded or otherwise overlapping. In such embodiments, a user may be able to swipe or otherwise scroll through the various secondary screens 22.

The contents to be displayed in the secondary screens 22 can vary. In the illustrated embodiment, the content of screen 14 could be a live camera showing a close up view of, for example, a conductor. Screen 16 can be a live camera showing a wide-angle view (e.g., a long shot) of a stage. Screen 18 can be an image montage that is relevant to a subject of the music piece being played on stage. In some embodiments, the image montage of screen 18 can be provided from existing content, such as, but not limited to, videos available from a video streaming service or other video library (e.g., YouTube or the like). Screen 20 can be a music score. In some embodiments, the display of the music score can be synchronized with the music piece being played on stage.

In some embodiments, when the user selects one of the plurality of the secondary screens 22, the content from the selected screen can be displayed in the main screen 12 and the other of the plurality of secondary screens 22 can be removed from the display. In some embodiments this can, for example, provide the user with an undistracted view of the main screen 12.

FIG. 1 illustrates the display 10 of the user's device with one main screen 12 and a row of four secondary screens 22 positioned at a lower portion of the main screen 12. In the illustrated embodiment, the main screen 12 can be configured to display a close up view of a conductor, which may be selected by the user from the row of four secondary screens 22 (e.g. the left most secondary screen 22 in the illustrated embodiment). From the left side to the right side of the row of secondary screens 22, the contents displayed in the illustrated embodiment can include the close up view of the conductor (e.g., screen 14 “Stream 1”), a wide angle view of the stage (e.g., screen 16 “Stream 2”), an image montage that may be relevant for the music piece being played on stage (e.g., screen 18 “Stream 3”), and a music score (e.g., screen 20 “Stream N”). It will be appreciated that the contents of screens 14-20 are examples, and that the content can vary by type of live event, content creator in charge of the live event, intended audience, or the like. In some embodiments, an image montage may include a photo or a video that may be relevant to the music piece being played on stage, so that the user's experience of the live event may be enhanced. For example, in some embodiments, an image montage (e.g., a video, slideshow, etc.) may give the user a music video like experience while the user is listening to the music piece performed in the live event.

In some embodiments, a music score may include notes from the composer, singer, content creator, and/or conductor. In some embodiments, some portions of the music score may be highlighted, or include annotations. By providing useful annotations and/or information on the music score, the user's experience (e.g. understanding of the music) in the live event may be enhanced.

By providing contents that are different from the user's point of view in the live event, the user's experience in the live event may be enhanced. The contents provided can be specifically generated or chosen by a content creator, the user typically can only select what to display in the main screen from the secondary screen. Thus, desired live event experience can be controlled by the content creator.

When, for example, a different music piece is being played on stage, the contents displayed in the row of secondary screens 22 can be changed accordingly.

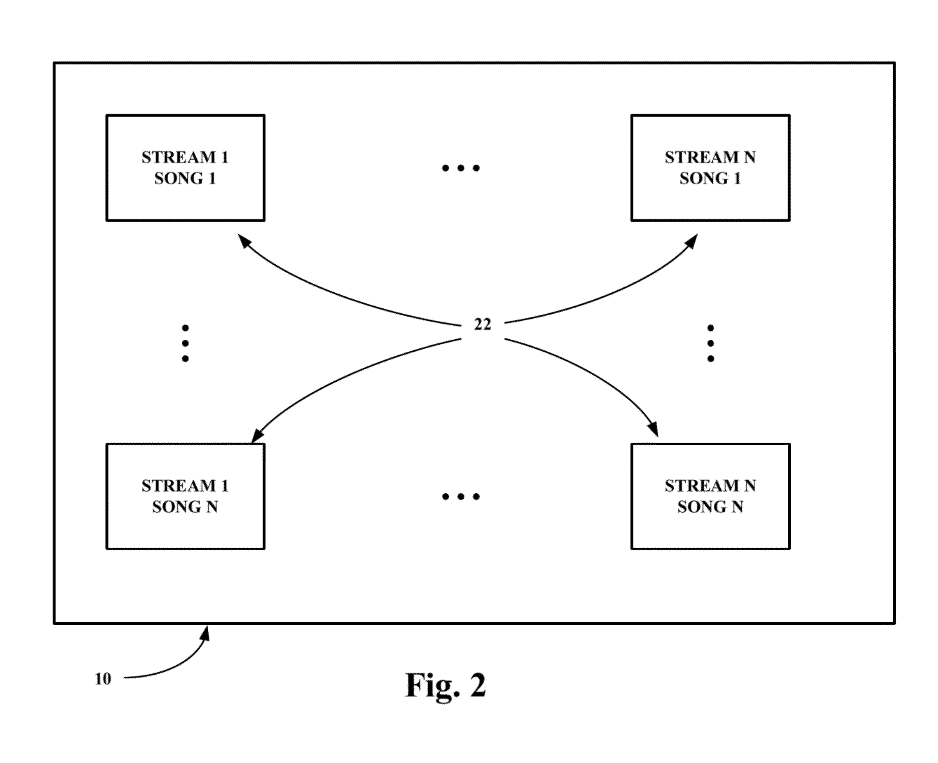

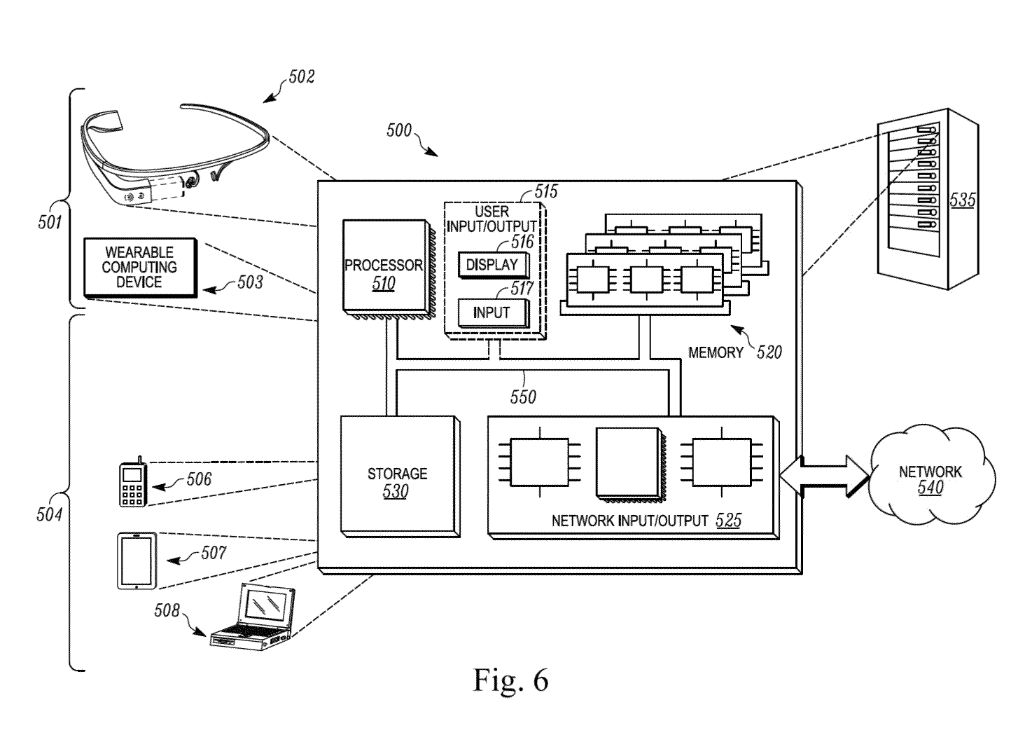

FIG. 2 illustrates a schematic diagram of a display 10 of a user's device when using a live event enhancing system as described in this specification, according to some embodiments. As illustrated, in a live event with N songs, contents to be displayed when a specific song is being played on stage in the live event may be configured as, for example, a content grid that includes a plurality of screens 22, and can be saved in a data storage device (e.g., a computer server such as server 535 in FIG. 6 below). Each of the plurality of screens 22 of the display 10 corresponds to a specific content. In some embodiments, the screens 22 can be displayed in a manner other than a grid. In the illustrated embodiment, song 1 can include streams 1 to stream N and there can be N songs. Each of the screens (e.g., stream 1 to stream N) can include a different content. For example, stream 1 to stream N of song 1 can include a close up view, a wide angle view, a montage and a music score can be chosen or generated for song 1, which correspond to the contents to be displayed in the plurality of secondary screens (e.g., the secondary screens 22 of FIG. 1). When song 1 is being played on stage, the first line of the content grid will be displayed on the user's display device. When song N is being played on stage, the second line of the content grid will be displayed, replacing the first line of the content grid. It is to be understood that in some embodiments, the content grid can be displayed on the user's display device based on time into the live event.

It is to be noted that the contents to be included in each of the grid can be chosen or generated before the live event, or can be generated during the live event. For example, the close up view and the wide-angle view typically have to be generated during the live event and fed by one or more cameras to the corresponding content grid, which may be saved in the storage device. The montage and the music score can be generated before the live event, and saved in the storage device.

It is understood that size and dimension of the content grid can be varied. By selecting the content in each of the grids, the content creator may not only control the contents to be fed to the user's display device, but also how the contents are displayed (e.g. which contents to be displayed on a specific secondary screen at a specific time point during the live event). The content creator maintains control over the user's experience in the live event. It is to be understood that in some embodiments, the contents can certainly be displayed randomly in the secondary screens.

It is understood that the contents generated during the live event, e.g. the close up shot, the wide-angle shot, can be varied during the live event. It is to be understood that, in some embodiments, the content creator can select and/or change the contents (e.g. the camera views) during the live event.

In some embodiments, the content grid can include a different number of rows, each of which can be displayed in a user's display device when the corresponding music piece is being played. For example, three secondary screens can be shown on the user's display device. In some embodiments, a live event can have a main theme of planets and each of the music pieces can be titled with a name of the planet (e.g., Mars, Venus, Mercury, etc.). When the music piece is being played, an image of the corresponding planet may be displayed. In some embodiments, when the user selects the displayed planet, information about the planet (e.g., a Wikipedia page of the planet, etc.) may be displayed on the main screen.

Generally, in a live event with a specific theme, more information related to the specific theme may be displayed in the user's display device. The information to be displayed can be controlled by a content creator to provide desired experience to the user.

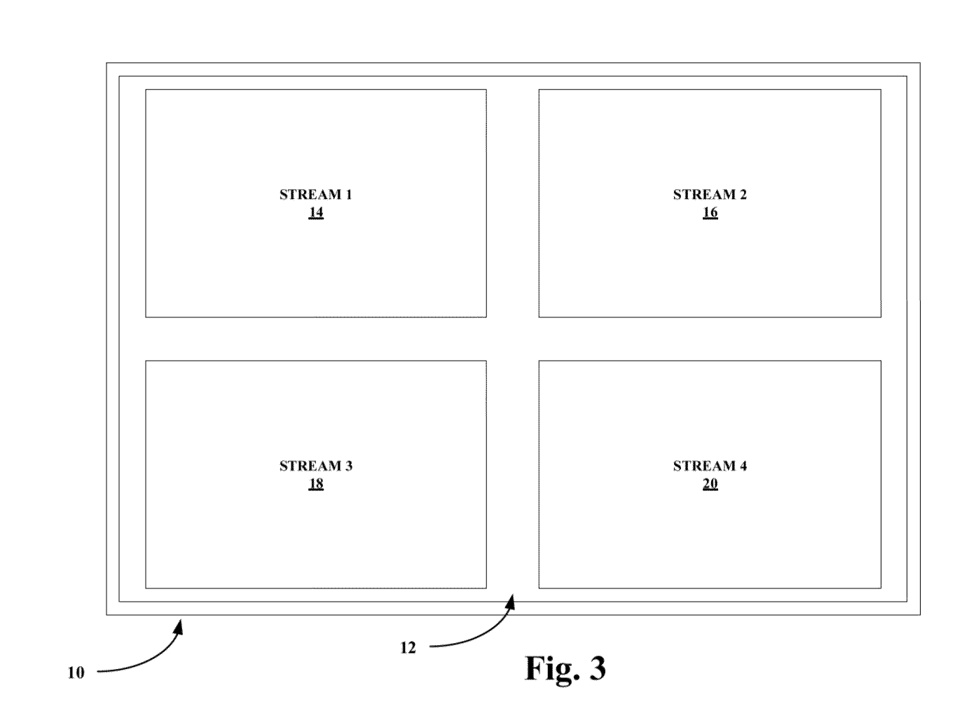

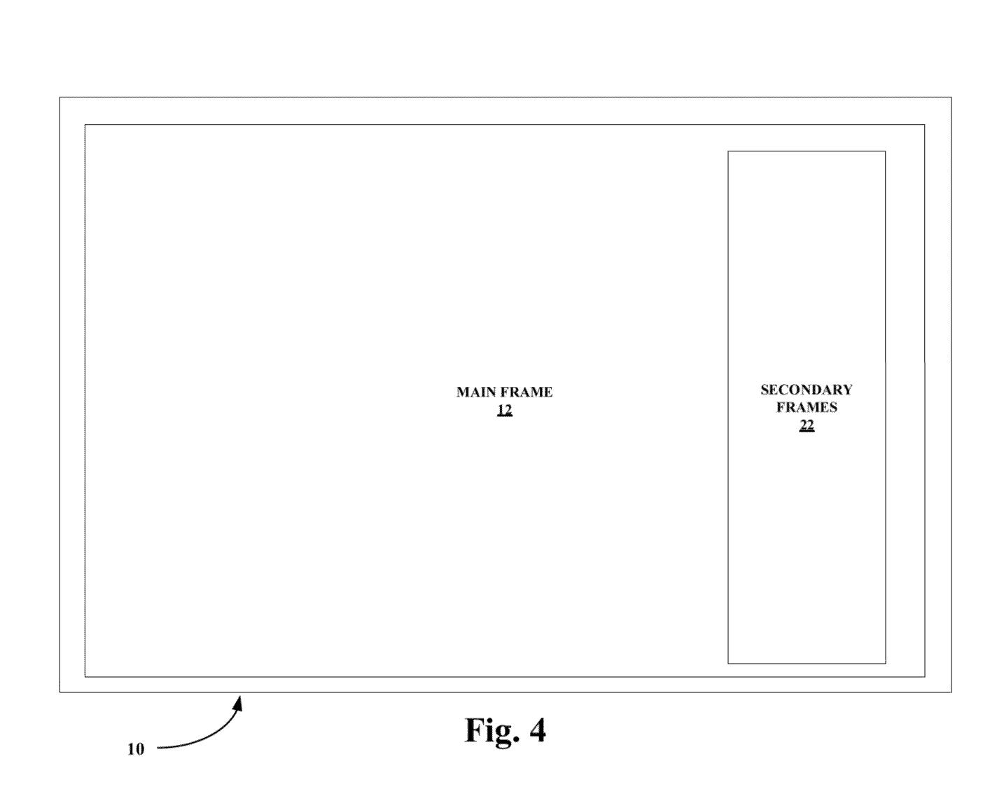

It is to be understood that an arrangement of the secondary screens can vary. For example, FIGS. 3 and 4 illustrate schematic diagrams of the display 10 of the user's device. In some embodiments, the secondary screens 22 can be arranged into a plurality of rows and columns. In some embodiments, the secondary screens 22 can overlap substantially with the main screen 12, with the understanding that the secondary screens 22 can also just overlap with a relatively small portion of the main screen 12. When a user selects the secondary screen 22 to be displayed in the main screen 12, the secondary screens 22 may disappear from the user's display device. In some embodiments, when the user selects the secondary screen 22 to be displayed in the main screen 12, the secondary screens 22 may remain showing on the display of the user's display device.

It is to be understood that in some embodiments, each of the secondary screens 22 may be configured as a gateway to another layer of available contents. For example, when a camera view is selected by a user, a plurality of different camera views may be shown on the user's display device. The user can then select the desired views to be displayed in the main screen 12.

As illustrated in FIG. 4, when the user selects a particular secondary screen 22 from the user's display device, more available camera views (e.g. conductor, first violin, first flute, cellos, percussion, reverse row, conductor point of view (POV), first violin POV, first flute POV, etc.) may be displayed on the user's display device for the user to select from.

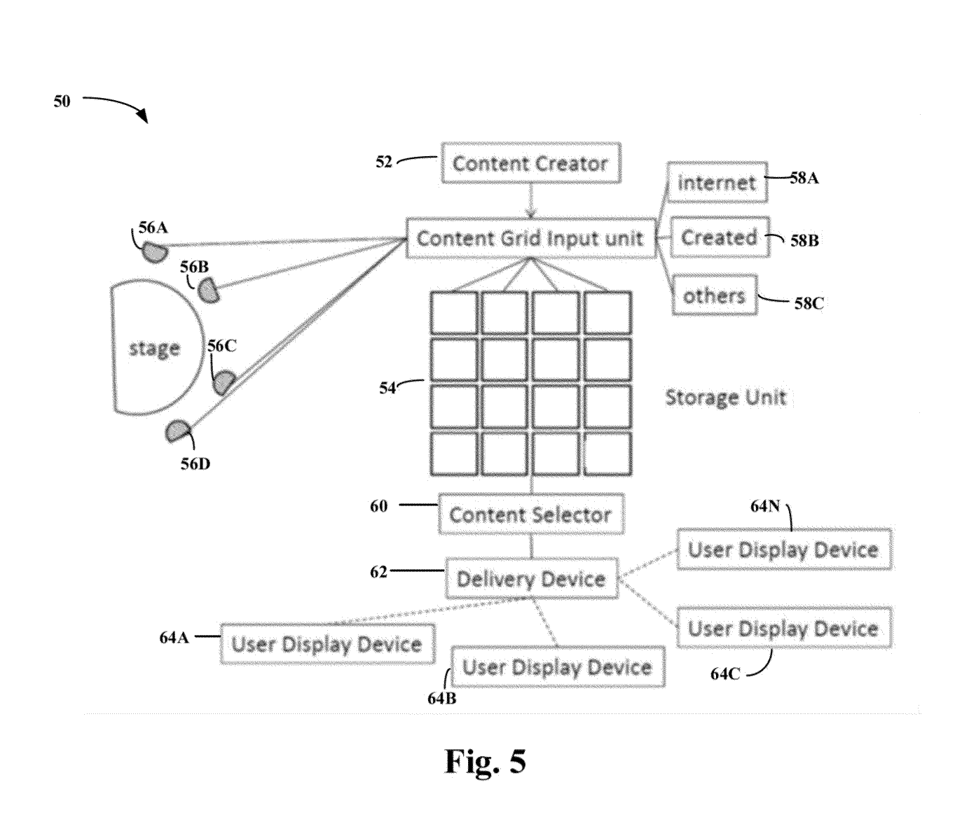

FIG. 5 illustrates a system 50 to enhance user's experience in a live event, according to some embodiments. The system 50 generally enables a content creator 52 to input contents from different sources into a content grid 54. It is to be noted that the content grid 54 is not intended to require a particular layout. The content grid 54 includes the contents that can be displayed in a user's display device during the live event. The system 50 generally includes one or more live content feeding devices (e.g., cameras 56A-56D) configured to provide live content feeds (e.g., contents occurring or occurred in the event) during the live event, and one or more outside content feeds 58A-58C (e.g., contents not occurred in the live event, such as, but not limited to, Internet content 58A, created contents 58B, and/or other suitable content sources 58C) to provide outside contents that may be relevant for the live event. The system 50 can also include a content grid input unit, which can be configured to receive the live content feed(s) and the outside content feed(s). The content grid input unit can be controlled by a content creator, so that specific contents can be input into specific grids in a content grid stored in a storage unit of the system. It is to be noted that the outside contents may be stored to the content grid before or during the live event.

The contents of the content grid 54 can be selected by a content selector 60 of the system. The content selector 60 can select the contents based on an event key, such as for example a timeline in the live event, an order of pieces played in the live event (e.g. an order of songs or music pieces played in a concert), an event camera angle, etc. Typically, the content selector 60 can select one row (or one column) from the content grid, or otherwise can select a plurality of content for screens to be displayed to the user. The event key may be pre-programmed so that the content selector 60 can function automatically during the live event. It is to be understood that the content selector can also be controlled or intervened by, for example, the content creator, during the live event.

The contents selected by the content selector 60 may be fed into a delivery device 62 of the system. The delivery device 62 may be configured to feed the contents to the user's display device 64A-64N in the live event. In some embodiments, the delivery device 62 may be a wireless transducer (e.g., a wireless router in a Wi-Fi network, etc.) or other suitable devices. The delivery device 62 can, in some embodiments, transmit data through a wireless connection using WiFi, Bluetooth, or other similar wireless communication protocols. In some embodiments, the delivery device 62 can transmit data through a cellular, 3G, 4G, or other wireless protocol. The user's display device 64A-64N may include a wearable optical head-mounted display (e.g. Google™ Glasses), a tablet, a smart phone, a portable TV, or other suitable display carried by the user in a live event.

FIG. 6 is a schematic diagram of an architecture for a computer device 500. The computer device 500 and any of the individual components thereof can be used for any of the operations described in accordance with any of the computer-implemented methods described herein.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of wearable computing devices 501, a variety of user devices 504, and a server device 535. The illustrated wearable computing devices 501 and user devices 504 are examples and are not intended to be limiting. Examples of the wearable computing devices 501 include, but are not limited to, glasses 502, or other wearable computing devices 503. The wearable computing devices 503 can include head-wearable computing devices as well as devices other than those wearable on a user's head as described herein. Examples include, but are not limited to, wrist-wearable computing devices or the like. It is to be appreciated that the glasses 502 may not have lenses in the manner that conventional glasses do. However, in some embodiments, the glasses 502 can additionally include lenses (prescription or non-prescription). Examples of the user devices 504 include, but are not limited to, a cellular/mobile phone 506, a tablet device 507, and a laptop computer 508. It is to be appreciated that the user devices 504 can include other devices such as, but not limited to, a personal digital assistant (PDA), a video game console, a television, or the like. In some embodiments, the devices 501, 504 can alternatively be referred to as client devices 501, 504. In such embodiments, the client devices 501, 504 can be in communication with the server device 535 through the network 540. One or more of the client devices 501, 504 can be in communication with another of the client devices 501, 504 through the network 540, according to some embodiments.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the memory 520, the storage 530, and the network I/O 540. The interconnect 550 can, for example, be one or more busses or the like. The processor 510 can be a single processor, multiple processors, or a single processor having multiple processing cores. In some embodiments, the processor 510 can be a single-threaded processor. In some embodiments, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In some embodiments, the user I/O 515 can physically be part of the device 501, 504. For example, wearable computing device 502, 503, the cellular/mobile phone 506, the tablet device 507, and the laptop 508 include the display 516 and input 517 that are part of the computer device 500. The server device 535 generally may not include the user I/O 515. In some embodiments, the server device 535 can be connected to the display 516 and input 517.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, an optical head-mounted display, or the like.

The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the devices 501, 504. In some embodiments the input 517 can be integrated with the display 516 such that both input and output are performed by the display 516.

The memory 520 is generally included to be representative of a random access memory such as, but not limited to, Static Random Access Memory (SRAM), Dynamic Random Access Memory (DRAM), or Flash. In some embodiments, the memory 520 can be a volatile memory. In some embodiments, the memory 520 can be a non-volatile memory. In some embodiments, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 530 is a computer readable medium. In some embodiments, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In some embodiments, the network I/O 525 can transmit data via the network 540 through a wireless connection using WiFi, Bluetooth, or other similar wireless communication protocols. In some embodiments, the computer device 500 can transmit data via the network 540 through a cellular, 3G, 4G, or other wireless protocol. In some embodiments, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website or GUI on the devices 501, 504. The server 535 can be representative of a data server, an application server, an Internet server, or the like.

Aspects described herein can be embodied as a system, method, or computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A method for enhancing a user's experience at a live event, the method comprising:
providing an application for computing device, the computing device including a display, the application permitting a user to concurrently display one or more screens on the display, the one more screens including additional content to supplement the live event;
receiving a request to view one of the one or more screens;
generating a user interface for displaying a requested screen corresponding to the one of the one or more screens; and
providing the user interface for display on the computing device.

2. The method according to claim 1, further comprising:
receiving a user command indicating the user would like to view a different screen; and
displaying the different screen associated with the user command.

3. The method according to claim 1, wherein the additional content includes live content from the live event.

4. The method according to claim 1, wherein the additional content includes prerecorded content to be displayed in accordance with one or more occurrences at the live event.

5. The method according to claim 1, wherein the user interface includes a plurality of screens.

6. The method according to claim 5, wherein the plurality of screens include a combination of live content from the live event being streamed to the user and prerecorded content.

7. The method according to claim 6, wherein the live content includes one or more camera views of the live event.

8. A live event enhancing system, comprising:
an application that is loadable onto a computing device, the computing device including a display, and that when loaded onto the computing device permits the computing device to display one or more screens on the display, communicate with a server to receive the one or more screens to be displayed;
the server able to communicate with the computing device and configured to receive a request for content from the computing device, identify the content, and send the content to the application,
wherein the content includes at least one of a live stream from a live event at which the computing device is located and a prerecorded content corresponding to the live event at which the computing device is located.

9. The live event enhancing system according to claim 8, wherein the application is further configured to permit an event attendee to switch between the one or more screens being displayed to view different content.

10. The live event enhancing system according to claim 8, wherein the computing device is a wearable computing device.

11. The live event enhancing system according to claim 10, wherein the wearable computing device is a head-wearable computing device.

12. The live event enhancing system according to claim 8, wherein the content is associated with a particular live event based on an event code.

13. The live event enhancing system according to claim 12, wherein the live event is a concert.

14. The live event enhancing system according to claim 13, wherein the content includes a music score, the music score being displayed concurrently with corresponding music notes being played during the live event.

15. A method, comprising:
providing a wearable computing device in a live event venue, the wearable computing device including an application configured for a user to view supplemental content for a live event while the live event is occurring; and
displaying the supplemental content to the wearable computing device.

16. The method according to claim 15, wherein the wearable computing device is a head-wearable computing device.

17. The method according to claim 15, wherein the supplemental content includes a live stream of the live event.

18. The method according to claim 15, wherein the supplemental content is prerecorded for a particular live event.

19. The method according to claim 15, further comprising receiving a request from the wearable computing device to display a particular content from the supplemental content.

20. The method according to claim 15, wherein the supplemental content includes a live stream of the live event and a prerecorded content for the live event.
